(19) United States
(12) Patent Application Publication
(10) Pub. No.: US 2019/0003575 A1
(43) Pub. Date: Jan. 3, 2019

(54) VEHICLE, ELECTRONIC CONTROL UNIT, AND METHOD OF CONTROLLING ELECTRONIC CONTROL UNIT

(71) Applicant: MANDO CORPORATION, Gyeonggi-do (KR)

(72) Inventor: Sangwon YUN, Seoul (KR)

(21) Appl. No.: 16/022,665

(22) Filed: Jun. 28, 2018

(30) Foreign Application Priority Data
Jun. 30, 2017 (KR) 10-2017-0083708

(51) Int. Cl. F16H 59/78; G05D 23/19; G05D 23/24; F25B 41/06

(52) U.S. Cl. CPC F16H 59/78; F25B 41/062; G05D 23/24; G05D 23/1913

(57) ABSTRACT

Disclosed herein are a vehicle, an electronic control unit (ECU), and a method of controlling an ECU, which are capable of deriving a temperature of a coil part using resistance of the coil part provided at the ECU and controlling the temperature of the coil part when the temperature of the coil part exceeds a predetermined temperature. The ECU includes a coil part to which a constant voltage is supplied, a sensor configured to measure a coil current flowing into the coil part and a coil voltage supplied to the coil part, a switching part configured to receive a switching signal and supply the coil current on the basis of the switching signal, and a controller configured to input the switching signal to the switching part and calculate a temperature of the coil part using the switching signal, the coil voltage, and the coil current.

### CROSS-REFERENCE TO RELATED APPLICATION

This application claims the benefit of Korean Patent Application No. 2017-0083708, filed on Jun. 30, 2017 in the Korean Intellectual Property Office, the disclosure of which is incorporated herein by reference.

### BACKGROUND

### 1. Field

Embodiments of the present disclosure relate to a vehicle, an electronic control unit (ECU), and a method of controlling an ECU, and more particularly, to a technique in which it is possible to derive a temperature of a coil part provided at an ECU and perform control on the basis of the derived temperature.

### 2. Description of the Related Art

An electronic control unit (ECU) is a processor configured to control various components provided in a vehicle on the basis of various electrical signals in the vehicle.

When a current flows into a coil part provided at the ECU, a magnetic force may be generated to drive a valve, and at this point, when a temperature of the coil part increases due to the current, internal resistance of the coil part is varied such that a control operation may be affected. Thus, there is a need to estimate a temperature of the coil part.

That is, when the current flows into the coil part so as to drive the valve, heat is generated such that the coil part may be damaged when overheated. Consequently, to prevent overheating of the coil part, there is a need to derive a temperature of the coil part according to an operating time and to control the ECU on the basis of the derived temperature.

To resolve the above-described problem, research is being conducted to detect a temperature of a coil part constituting an ECU.

### SUMMARY

Therefore, it is an aspect of the present disclosure to provide a vehicle, an electronic control unit (ECU), and a method of controlling an ECU, which are capable of, by using the resistance of a coil part provided at the ECU, deriving a temperature of the coil part and controlling the temperature of the coil part when the temperature of the coil part exceeds a predetermined temperature.

Additional aspects of the present disclosure will be set forth in part in the description which follows and, in part, will be obvious from the description, or may be learned by practice of the disclosure.

In accordance with one aspect of the present disclosure, an electronic control unit (ECU) includes a coil part to which a constant voltage is supplied, a sensor configured to measure a coil current flowing into the coil part and a coil voltage supplied to the coil part, a switching part configured to receive a switching signal and supply the coil current on the basis of the switching signal, and a controller configured to input the switching signal to the switching part and calculate a temperature of the coil part using the switching signal, the coil voltage, and the coil current.

The controller may calculate resistance of the coil part on the basis of the coil voltage and the coil current and calculate the temperature of the coil part using the resistance of the coil part.

The controller may calculate the temperature of the coil part using a reference resistance of the coil part stored in advance and the resistance of the coil part.

The switching signal may include a pulse width modulation (PWM) signal having a pulse signal of which a width is able to be modulated and duty information based on the width of the pulse signal.

The controller may calculate the resistance of the coil part using the duty information, a constant voltage, and the coil current, and calculate the temperature of the coil part on the basis of the resistance of the coil part.

When the temperature of the coil part exceeds a predetermined temperature, the controller may vary the switching signal to reduce the coil current.

When the temperature of the coil part exceeds the predetermined temperature, the controller may vary the duty information to reduce the coil voltage.

The controller may control opening or closing of a valve electromagnetically connected to the coil part by controlling the switching signal.

In accordance with another aspect of the present disclosure, a method of controlling an electronic control unit (ECU) includes measuring a coil current flowing into a coil part and a coil voltage supplied to the coil part, supplying the coil current on the basis of a switching signal, and calculating a temperature of the coil part using the switching signal, the coil voltage, and the coil current.

The calculating of the temperature of the coil part may include calculating resistance of the coil part on the basis of the coil voltage and the coil current, and calculating the temperature of the coil part using the resistance of the coil part.

The calculating of the temperature of the coil part may include calculating the temperature of the coil part using a reference resistance of the coil part stored in advance and the resistance of the coil part.

The switching signal may include a pulse width modulation (PWM) signal having a pulse signal of which a width is able to be modulated and duty information based on the width of the pulse signal.

The calculating of the temperature of the coil part may include calculating the resistance of the coil part using the duty information, a constant voltage, and the coil current, and calculating the temperature of the coil part on the basis of the resistance of the coil part.

The method may further include varying the switching signal to reduce the coil current when the temperature of the coil part exceeds a predetermined temperature.

The method may further include varying the duty information to reduce the coil voltage when the temperature of the coil part exceeds a predetermined temperature.

The method may further include controlling opening or closing of a valve electromagnetically connected to the coil part by controlling the switching signal.

In accordance with still another aspect of the present disclosure, a vehicle includes a coil part to which a constant voltage is supplied, a sensor configured to measure a coil current flowing into the coil part and a coil voltage supplied to the coil part, a switching part configured to receive a switching signal and supply the coil current on the basis of the switching signal, and a controller configured to input the switching signal to the switching part and calculate a temperature of the coil part using the switching signal, the coil voltage, and the coil current, wherein the controller calculates a resistance of the coil part on the basis of the coil voltage and the coil current and calculates the temperature of the coil part using the resistance of the coil part.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a diagram illustrating an exterior of a vehicle according to one embodiment of the present disclosure;

FIG. 2 is a diagram illustrating an internal structure of the vehicle according to one embodiment of the present disclosure;

FIG. 3 is a control block diagram according to one embodiment of the present disclosure;

FIG. 4 is a cross-sectional view of an electronic control unit (ECU) according to one embodiment of the present disclosure;

FIG. 5 is a circuit diagram of the ECU according to one embodiment of the present disclosure;

FIGS. 6A and 6B are diagrams illustrating a switching signal according to one embodiment of the present disclosure; and

FIG. 7 is a flowchart according to one embodiment of the present disclosure.

### DETAILED DESCRIPTION

Like reference numerals refer to like components throughout this disclosure. This specification does not describe all components of embodiments, and common descriptions in the technical field to which the present disclosure pertains and redundant descriptions between the embodiments will be omitted. Terms “part,” “module,” “member,” and “block” used in this specification may be implemented in software or hardware, and according to embodiments, a plurality of “parts,” “modules,” “members,” and “blocks” can be implemented in a single component or a single “part,” “module,” “member,” or “block” can include a plurality of components.

Throughout this specification, when a part is referred to as being “connected” to other part, it includes not only a direct connection but also an indirect connection, and the indirect connection includes a connection through a wireless communication network.

Further, when a part is referred to as “including” a component, this means that the part can include another element, and does not exclude another element unless specifically stated otherwise.

Throughout this specification, when a member is referred to as being “on” other member, this includes not only when the member is in contact with the other member, but also when another member is present between the member and the other member.

Terms “first,” “second,” and the like are used to distinguish one component from other component, and components are not limited by these terms.

The singular forms include plural forms unless the context clearly notes otherwise.

In each step, a reference numeral is used for convenience of description, and this reference numeral does not describe the order of the steps, and the steps may be differently performed from the described order unless clearly specified in the context.

Hereinafter, an operation principle and embodiments of the present disclosure will be described with reference to the accompanying drawings.

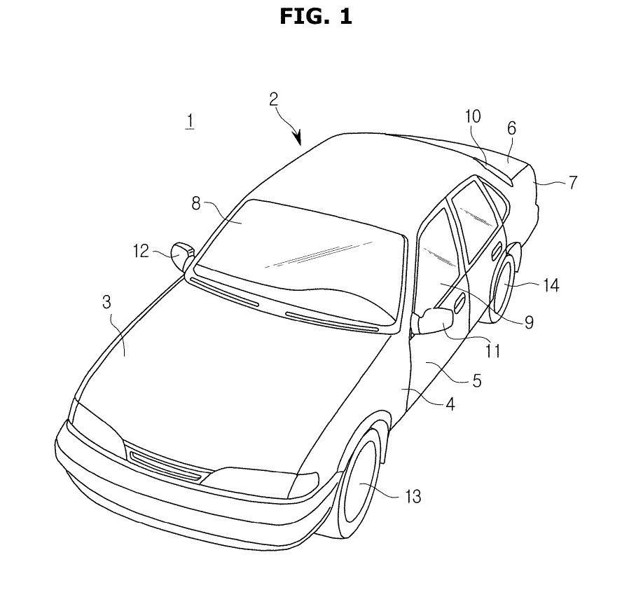

FIG. 1 is a diagram illustrating an exterior of a vehicle according to one embodiment of the present disclosure.

Referring to FIG. 1, a vehicle 1 includes a vehicle body 2 constituting an exterior of the vehicle 1, and wheels 13 and 14 configured to move the vehicle 1. The vehicle body 2 includes a hood 3, a front fender 4, a door 5, a trunk lid 6, and a quarter panel 7.

Further, a front window 8 installed at a front side of the vehicle body 2 and configured to provide a front view from the vehicle 1, a side window 9 configured to provide a side view from the vehicle 1, side-view mirrors 11 and 12 installed at doors 5 and configured to provide rear and side views from the vehicle 1, and a rear window 10 installed at a rear side of the vehicle body 2 and configured to provide a rear view from the vehicle 1 may be provided at an outer side of the vehicle body 2.

The wheels 13 and 14 include a front wheel 13 provided at a front side of the vehicle 1 and a rear wheel 14 provided at a rear side of the vehicle 1, and a driving mechanism (not shown) provides a rotating force to the front wheel 13 or the rear wheel 14 so as to allow the vehicle 1 to move forward or backward. Such a driving mechanism may employ an engine configured to generate a rotating force by combusting fossil fuel, or a motor configured to generate a rotating force by receiving power from an electric condenser.

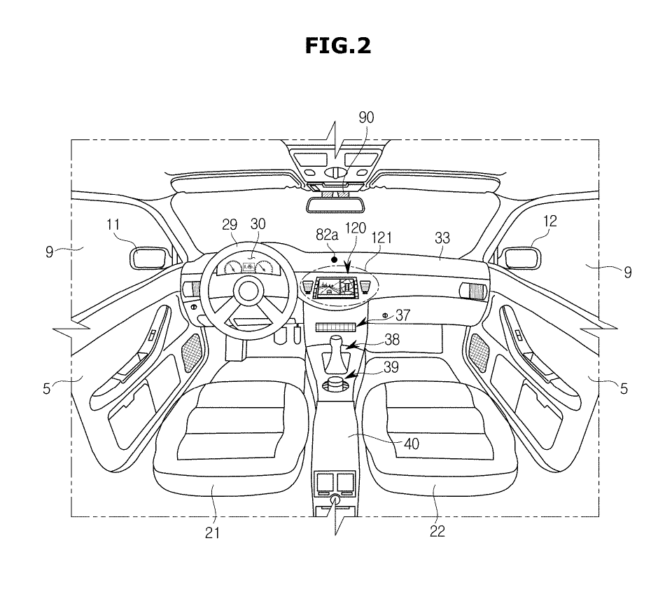

FIG. 2 is a diagram illustrating an internal structure of the vehicle 1 according to one embodiment of the present disclosure.

Referring to FIG. 2, an interior of the vehicle 1 includes a seat 20 on which a passenger sits, a dashboard 33, an instrument panel 30 (that is, a cluster) disposed on the dashboard 33 and having a tachometer, a speedometer, a cooling water thermometer, a fuel gauge, turn signal indicator lights, a high beam indicator light, a warning light, a seat belt indicator light, an odometer, a tripometer, an automatic shift lever indicator light, a door open warning light, an engine oil warning light, and a low fuel warning light which are disposed in the cluster 30, and a steering wheel 29 configured to control a traveling direction of the vehicle 1, and a center fascia 35 in which an air outlet and a control panel of an air conditioner and audio equipment are disposed.

A center inputter of a jog-shuttle type or a hard key type may be provided at the center console 37. The center console 37 refers to a part disposed between a driver seat 21 and a passenger seat 22 and in which a gear shift lever 38 and a tray 40 are formed.

The seat 20 includes the driver seat 21 at which a driver sits, the passenger seat 22 at which a passenger sits, and a back seat positioned at a rear side of the interior of the vehicle 1.

The cluster 30 may be digitally implemented. That is, a digital-type cluster 30 displays vehicle information and driving information as images.

The center fascia 35 is a part positioned at the dashboard 33 between the driver seat 21 and the passenger seat 22, and the air outlet, a cigar jack, and the like may be installed at the center fascia 35.

An audio video navigation (AVN) device 121 may be provided inside the vehicle 1. The AVN device 121 refers to a terminal capable of not only providing to a user a navigation function for route guidance to a destination but also integrally providing audio and video functions.

The AVN device 121 may selectively display at least one of an audio screen, a video screen, and a navigation screen through a display 120, as well as display a screen for additional functions related to control of the vehicle 1.

The display 120 may be positioned at the center fascia 35 which is a central region of the dashboard 33. According to one embodiment, the display 120 may be implemented with a liquid crystal display (LCD), light emitting diodes (LEDs), a plasma display panel (PDP), organic light emitting diodes (OLEDs), or a cathode ray tube but is not limited thereto.

A center inputter 39 of a jog-shuttle type or a hard key type may be provided at the center console 37. The center inputter 39 may perform all or some functions of the AVN device 121.

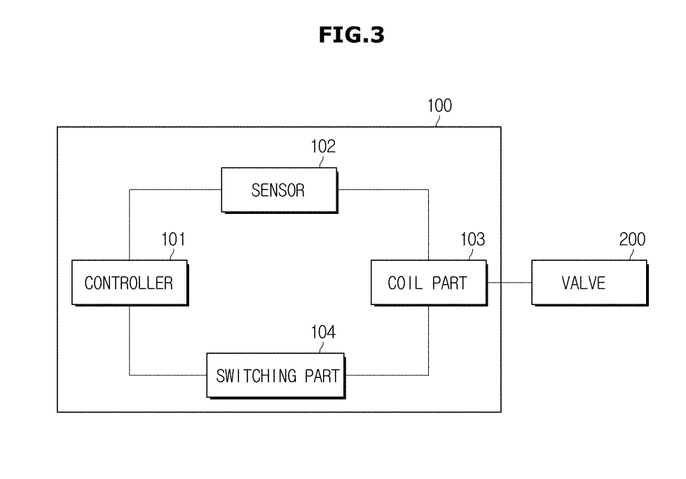

FIG. 3 is a control block diagram according to one embodiment of the present disclosure.

Referring to FIG. 3, the vehicle 1 may include an electronic control unit (ECU) 100 having a controller 101, a sensor 102, a switching part 104, and a coil part 103, and a valve 200 connected to the ECU 100.

The coil part 103 may be configured with a solenoid coil. The coil part 103 may generate a magnetic force when a current flows into the coil part 103. The valve 200 connected to the coil part 130 may be controlled using the magnetic force generated by the coil part 103. Meanwhile, when a current flows into the coil part 103 so as to control the valve 200, heat may be generated at the coil part 130, and when a temperature of the coil part 103 exceeds a predetermined temperature due to excessive heat generation, the coil part 103 may be damaged.

The switching part 104 may receive a switching signal from the outside and may be turned on or off in response to the switching signal, and when the switching part 104 is turned on, a current may flow into the coil part 103. The switching part 104 may include a metal oxide semiconductor field effect transistor (MOSFET), and the MOSFET may be a FET, which is most commonly used in digital and analog circuits, is configured with channel in an n-type or p-type semiconductor material, and is generally classified into an n-type MOSFET (NMOSFET), a p-type MOSFET (PMOSFET), and a complementary MOSFET (CMOSFET) according to semiconductor material. The MOSFET may include a gate terminal, a source terminal, and a drain terminal.

The MOSFET may have a cut-off region, a linear region, and a saturation region according to a voltage applied between the gate terminal and the source terminal. The cut-off region is a region in which a sufficient voltage is not applied between the gate terminal and the source terminal and thus the MOSFET is in a non-operating state, and the linear region is a region in which the MOSFET operates in proportion to a voltage applied between the gate terminal and the source terminal. The saturation region is a region in which a voltage of a predetermined level or more is applied between the gate terminal and the source terminal and thus a constant voltage is transmitted. In the present disclosure, the switching part 104 may include the MOSFET. The coil part 103 is connected to the switching part 104, and when a voltage of a predetermined level or more is applied to the switching part 104, the coil part 103 is operated. A detailed description relating to the aforementioned will be made below.

The sensor 102 may sense a current flowing into the coil part 103 and a voltage applied thereto. A constant voltage is supplied to the coil part 103 and a current does not flow or flows into the coil part 103 according to an operation of the switching part 104. When a current flows into the coil part 103 on the basis of a signal of the switching part 104, the sensor 102 may sense the current flowing into the coil part 103. Further, when the current flows into the coil part 103, the sensor 102 may measure a voltage across both ends of the coil part 103 to sense a voltage applied to the coil part 103. The current and the voltage, which are sensed by the sensor 102, may be transmitted to the controller 101, and the controller 101 may derive the resistance of the coil part 103 on the basis of the current and the voltage and thus derive a temperature of the coil part 103 on the basis of the resistance of the coil part 103.

The controller 101 may operate the switching part 104 by transmitting a signal thereto and receive current and voltage information from the sensor 102. The controller 101 may include a memory configured to store a program for performing the operations described above and below and various data related thereto, a processor configured to execute the program stored in the memory, a micro controller unit (MCU), and the like. Specifically, the controller 101 may calculate the resistance of the coil part 103 on the basis of the voltage and the current, which are transmitted by the sensor 102, and derive the temperature of the coil part 103 using the resistance thereof. When deriving the temperature of the coil part 103, the controller 101 may store a reference resistance of the coil part 103 in advance and calculate the temperature of the coil part 103 using the stored reference resistance and the derived resistance of the coil part 103.

Meanwhile, the controller 101 may control the switching part 104 with a switching signal including a pulse signal, and the switching signal may include a pulse width modulation (PWM) signal. A detailed description relating thereto will be given below.

At least one component may be added or omitted corresponding to performance of the components of the ECU 100 shown in FIG. 3. Further, those skilled in the art may easily understand that relative positions of the components may be changed corresponding to the performance or structure of a system.

Meanwhile, each of the components shown in FIG. 3 refers to a software component and/or a hardware component such as a field programmable gate array (FPGA) or an application specific integrated circuit (ASIC).

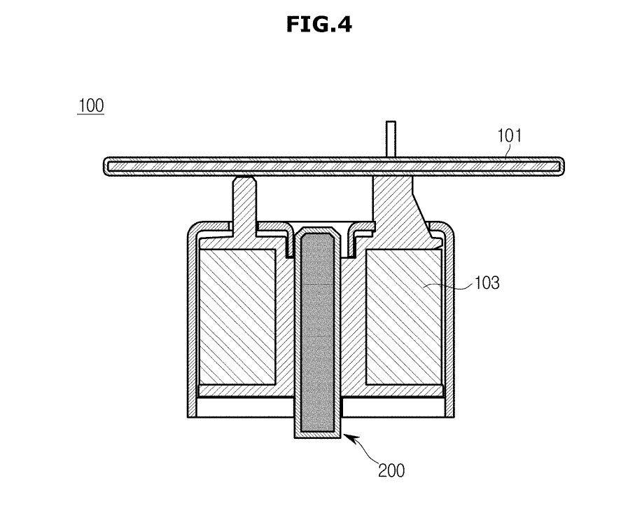

FIG. 4 is a cross-sectional view of the ECU 100 according to one embodiment of the present disclosure.

Referring to FIG. 4, the ECU 100 may include the controller 101 and the coil part 103, and the coil part 103 may be coupled to the valve 200.

When the controller 101 inputs a switching signal so as to operate the coil part 103, the coil part 103 may control a hydraulic pressure using the valve 200 coupled to the coil part 103. The valve 200 controlled by the coil part 103 may basically include a directional control valve configured to control a direction of a flow of hydraulic fluid, a pressure control valve configured to regulate a maximum output and maintain a required pressure in a hydraulic pressure circuit so as to prevent overload and protect hydraulic equipment, and a flow rate control valve configured to control a flow rate by varying a cross-sectional area of a flow path and change a speed and the number of revolutions of an actuator.

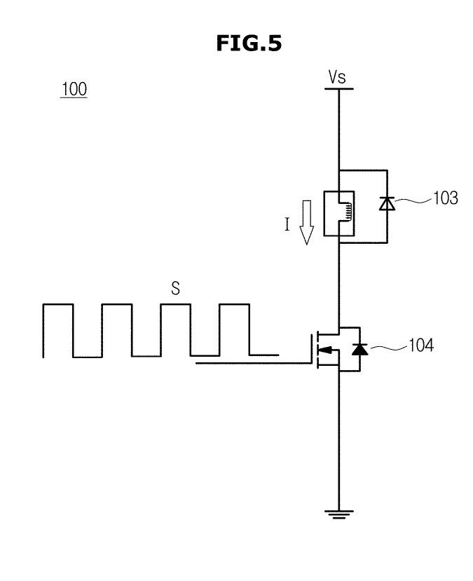

FIG. 5 is a circuit diagram of the ECU 100 according to one embodiment of the present disclosure.

Referring to FIG. 5, FIG. 5 shows a switching signal S supplied from the controller 101 to the switching part 104, a coil current I flowing into the coil part 103, and a coil voltage V supplied to the coil part 103. The controller 101 may supply the switching signal S to the switching part 104. FIG. 5 shows the switching signal S provided in the form of a pulse. The switching signal S supplied from the controller 101 is for controlling the coil current I flowing into the coil part 103 by turning on or off the switching part 104, so that the coil current I flowing into the coil part 103 is determined by a duty ratio which is a signal period of the switching signal S. An operation of the controller 101 for determining the coil current I on the basis of the switching signal S supplied to the switching part 104 will be described in detail below.

Meanwhile, a constant voltage is supplied to the coil part 103 such that the coil current I may flow when the switching part 104 is turned on, the coil current I flowing into the coil part 103 and the coil voltage V applied to the coil part 103 due to the flowing of the coil current I may be transmitted to the controller 101 by the sensor 102. The controller 101 may derive the resistance of the coil part 103 using the coil current I and the coil voltage V which are sensed by the sensor 102. Equation 1 may be used to derive the resistance of the coil part 103.

$$R = \frac{V}{I} \qquad [ Equation 1 ]$$

Referring to Equation 1, R refers to the resistance of the coil part 103, V refers to a voltage supplied to the coil part 103, and I refers to a current flowing into the coil part 103. The controller 101 may receive the coil current I and the coil voltage V from the sensor 102 and derive the resistance of the coil part 103 using Equation 1. Further, the resistance of the coil part 103 derived by the controller 101 may be used to derive a temperature of the coil part 103 on the basis of Equation 2.

$$T = \frac{( \frac{R}{{R}^{′}} - 1 )}{0.00425} \qquad [ Equation 2 ]$$

Referring to Equation 2, T refers to a temperature of the coil part 103, R refers to the resistance of the coil part 103 derived by the controller 101, and R′ refers to a reference resistance stored in the controller 101 in advance. The reference resistance refers to the resistance of the coil part 103 at a temperature of 0° C. As described above, the controller 101 may calculate the temperature of the coil part 103 and the resistance thereof on the basis of Equation 2.

Further, when the temperature of the coil part 103, which is derived from the above-described method, exceeds a predetermined temperature, the controller 101 may determine the coil part 103 as being overheated, and when the temperature of the coil part 103 is determined as being high, the controller 101 may control the coil current I flowing into the coil part 103 to vary the temperature of the coil part 103. A detailed description relating thereto will be given below. The operation described in FIG. 5 is merely one embodiment in which the resistance of the coil part 103 is calculated and the temperature of the coil part 103 is calculated on the basis of the calculated resistance of the coil part 103 according to the present disclosure, and any kind of operation performed by a configuration of the present disclosure may be possible as long as it is possible to derive the temperature of the coil part 103 on the basis of the coil current I and the coil voltage V.

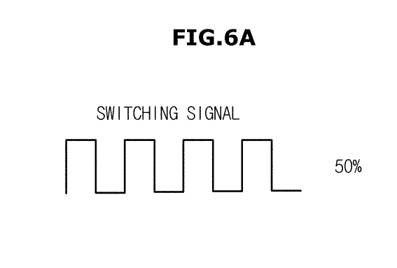

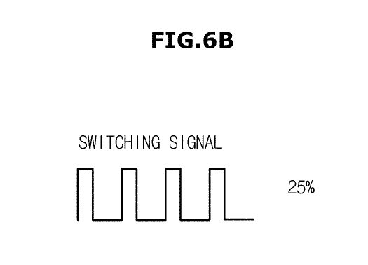

FIGS. 6A and 6B are diagrams illustrating a switching signal according to one embodiment of the present disclosure.

Referring to 6A and 6B, the switching signal supplied from the controller 101 to the switching part 104 may include a pulse signal. Alternatively, the controller 101 may supply a PWM signal to the switching part 104. The PWM signal is a signal which is obtained by periodically modulating a pulse width through a method of converting an analog signal into a digital signal. A ratio of a pulse signal to a period is referred to as a duty ratio, and when a switching signal having a large duty ratio is supplied, the switching part 104 is in a longer turned-on state such that more current may be supplied to the coil part 103. A relationship between the duty ratio of the switching signal and a coil voltage may be expressed by Equation 3.

V=VS×d [Equation 3]

Referring to Equation 3, VS refers to a constant voltage applied to the coil part 103, and d refers to the duty of the switching signal. That is, the coil voltage may be supplied to the coil part 103 according to a value obtained by multiplying the constant voltage by the duty ratio. Further, as described above, since the coil current flows into the coil part 103 in proportion to the coil voltage supplied to the coil part 103, the coil current may be controlled by controlling the coil voltage, and the coil voltage may be controlled by the duty of the switching signal such that the coil current flowing into the coil part 103 may also be controlled by controlling the duty of the switching signal.

Referring to FIGS. 6A and 6B, FIG. 6A shows a switching signal having a duty ratio of 50%, and FIG. 6B shows a switching signal having a duty ratio of 25%.

When the coil part 103 may be operated using the switching signal shown in FIG. 6A according to one embodiment and the temperature of the coil part 103 exceeds a predetermined temperature, the coil part 103 may be damaged, such that there is a need to control the coil current flowing into the coil part 103. In this case, the controller 101 may adjust the duty ratio of the switching signal. According to one embodiment, the controller 101 may reduce the duty ratio from 50% to 25%.

FIG. 6B shows the switching signal having the duty ratio of 25% according to the result of the above-described operation. The duty ratio of the switching signal shown in FIG. 6B is less than that of the switching signal shown in FIG. 6A, such that a lesser coil voltage may be applied to the coil part 103 and a lesser coil current may flow into the coil part 103 to drop the temperature of the coil part 103. In summary, when the temperature of the coil part 103 is determined as being higher than or equal to the predetermined temperature, the controller 101 may vary the duty ratio of the switching signal, control the coil current flowing into the coil part 103, and drop the temperature of the coil part 103.

However, the switching signals shown in FIGS. 6A and 6B are merely one embodiment of the present disclosure, and thus there is no limitation on the type of the switching signal, and on the duty ratio of the switching signal, which are supplied from the controller 101 to the switching part 104.

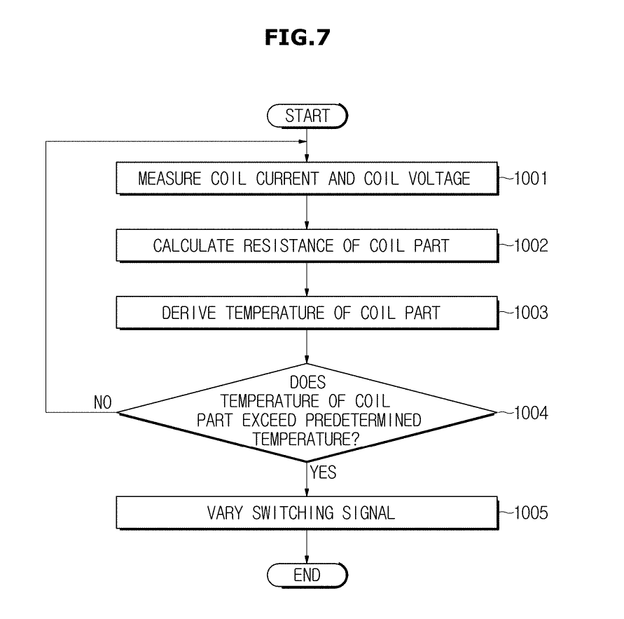

FIG. 7 is a flowchart according to one embodiment of the present disclosure.

Referring to FIG. 7, the sensor 102 may sense a coil current flowing into the coil part 103 and a coil voltage applied to the coil part 103. The controller 101 may calculate resistance of the coil part 103 on the basis of the coil current and the coil voltage which are sensed by the sensor 102. Since the resistance of the coil part 103 is varied according to temperature, a temperature of the coil part 103 may be derived on the basis of a reference resistance value stored in the controller 101 in advance and the resistance of the coil part 103. When the derived temperature of the coil part 103 exceeds the predetermined temperature, the coil part 103 may be damaged, such that the controller 101 should reduce the coil current flowing into the coil part 103, and at this point the controller 101 may control the coil current flowing into the coil part 103 by varying a switching signal. Specifically, the duty ratio of the switching signal may be varied to reduce the coil current flowing into the coil part 103, and when the coil current flowing into the coil part 103 is reduced, the temperature of the coil part 103 may be dropped.

As is apparent from the above description, the vehicle, the ECU, and the method of controlling an ECU according to the embodiments can, by using resistance of a coil part provided at the ECU, derive a temperature of the coil part and control the temperature of the coil part when the temperature of the coil part exceeds a predetermined temperature.

The disclosed embodiments may be implemented in the form of a recording medium storing commands executable by a computer. The commands may be stored in the form of program codes and, when executed by a processor, may generate a program module to perform the operations of the disclosed embodiments. The recording medium may be implemented as a computer-readable recording medium.

The computer-readable recording medium includes all kinds of recording media storing instructions which are decipherable by a computer. For example, there may be a read only memory (ROM), a random access memory (RAM), a magnetic tape, a magnetic disk, a flash memory, an optical data storage device, and the like.

Hereinbefore, the disclosed embodiments have been described with reference to the accompanying drawings. It would be appreciated by those skilled in the art to which the present invention pertains that other forms different from the disclosed embodiments can be implemented without departing from the technical spirit and essential features of the present disclosure. The disclosed embodiments are illustrative and should not be construed as limitative.

What is claimed is:

1. An electronic control unit (ECU) comprising:
a coil part to which a constant voltage is supplied;
a sensor configured to measure a coil current flowing into the coil part and a coil voltage supplied to the coil part;
a switching part configured to receive a switching signal and supply the coil current on the basis of the switching signal; and
a controller configured to input the switching signal to the switching part and calculate a temperature of the coil part using the switching signal, the coil voltage, and the coil current.

2. The ECU of claim 1, wherein the controller calculates resistance of the coil part on the basis of the coil voltage and the coil current and calculates the temperature of the coil part using the resistance of the coil part.

3. The ECU of claim 2, wherein the controller calculates the temperature of the coil part using a reference resistance of the coil part stored in advance and the resistance of the coil part.

4. The ECU of claim 1, wherein the switching signal includes a pulse width modulation (PWM) signal having a pulse signal of which a width is modulated and duty information based on the width of the pulse signal.

5. The ECU of claim 4, wherein the controller calculates resistance of the coil part using the duty information, a constant voltage, and the coil current, and calculates the temperature of the coil part on the basis of the resistance of the coil part.

6. The ECU of claim 1, wherein, when the temperature of the coil part exceeds a predetermined temperature, the controller varies the switching signal to reduce the coil current.

7. The ECU of claim 4, wherein, when the temperature of the coil part exceeds a predetermined temperature, the controller varies the duty information to reduce the coil voltage.

8. The ECU of claim 1, wherein the controller controls opening or closing of a valve electromagnetically connected to the coil part by controlling the switching signal.

9. A method of controlling an electronic control unit (ECU), comprising:
measuring a coil current flowing into a coil part and a coil voltage supplied to the coil part;
supplying the coil current on the basis of a switching signal; and
calculating a temperature of the coil part using the switching signal, the coil voltage, and the coil current.

10. The method of claim 9, wherein the calculating of the temperature of the coil part includes:
calculating resistance of the coil part on the basis of the coil voltage and the coil current; and
calculating the temperature of the coil part using the resistance of the coil part.

11. The method of claim 10, wherein the calculating of the temperature of the coil part includes calculating the temperature of the coil part using a reference resistance of the coil part stored in advance and the resistance of the coil part.

12. The method of claim 9, wherein the switching signal includes a PWM signal having a pulse signal of which a width is modulated and duty information based on the width of the pulse signal.

13. The method of claim 12, wherein the calculating of the temperature of the coil part includes:
calculating the resistance of the coil part using the duty information, a constant voltage, and the coil current; and
calculating the temperature of the coil part on the basis of the resistance of the coil part.

14. The method of claim 9, further comprising varying the switching signal to reduce the coil current when the temperature of the coil part exceeds a predetermined temperature.

15. The method of claim 12, further comprising varying the duty information to reduce the coil voltage when the temperature of the coil part exceeds a predetermined temperature.

16. The method of claim 9, further comprising controlling opening or closing of a valve electromagnetically connected to the coil part by controlling the switching signal.

17. A vehicle comprising:
a coil part to which a constant voltage is supplied;
a sensor configured to measure a coil current flowing into the coil part and a coil voltage supplied to the coil part;
a switching part configured to receive a switching signal and supply the coil current on the basis of the switching signal; and
a controller configured to input the switching signal to the switching part and calculate a temperature of the coil part using the switching signal, the coil voltage, and the coil current,
wherein the controller calculates a resistance of the coil part on the basis of the coil voltage and the coil current and calculates the temperature of the coil part using the resistance of the coil part.
